(19) United States
(12) Patent Application Publication
(10) Pub. No.: US 2008/0237152 A1
(43) Pub. Date: Oct. 2, 2008

(54) CARTRIDGE SEPARATOR FOR IMMISCIBLE LIQUIDS

(76) Inventor: Amine BENACHENHOU, Montreal (CA)

Correspondence Address: OGILVY RENAULT LLP, 1981 MCGILL COLLEGE AVENUE, SUITE 1600, MONTREAL, QC, H3A2Y3, CA

(21) Appl. No.: 12/055,459

(22) Filed: Mar. 26, 2008

(30) Foreign Application Priority Data
Mar. 26, 2007 (CA) 2,582,585

(51) Int. Cl. B01D 17/02; B01D 21/34; B01D 27/07; B01D 29/92; B01D 21/30

(52) U.S. Cl. 210/799; 210/101; 210/136; 210/442; 210/416.5

(57) ABSTRACT

A separator of the present invention provides a means for separating a immiscible dispersion of at least one oil from water. The separator adapted for use with a flow generator, includes a housing, a coalescing cartridge within the housing, the cartridge retains a coalescing media and defines at least one cavity or passage, permitting flow of the dispersion into and out of the passage; and a flow regulator comprising a constriction and the regulator displaceable between an open and a closed position and permitting liquid flow out of the passage when in the open position. The separator allows a greater throughput of coalesced oil/water dispersions through the separator due to removal during of coalesced oil and clarified oil during regular operational mode and the backwash mode, and further permits the use of the incoming or non-coalesced dispersion for backwash mode

### CROSS-REFERENCE TO RELATED APPLICATIONS

The present application claims priority on Canadian Patent application CA 2,582,585 filed on Mar. 26, 2007, the entire contents of which is incorporated herein by reference.

### TECHNICAL FIELD

The invention relates to a separator of immiscible liquids and particularly to a cartridge type separator.

### BACKGROUND ART

Separators of immiscible liquids are known in the art. U.S. Pat. No. 1,947,709 by M. E. Garrison et al., teaches an agglomerating apparatus which is used for a dispersed phase of a petroleum emulsion having minute water particles distributed throughout a body of oil. The apparatus of Garrison et al. includes a chamber filled with a mass of “Alundum”, glass wool or other material which is water wetted in the presence of oil. The emulsion is passed upwardly through the mass within the chamber. During passage through the mass within the chamber, particles agglomerate into larger water particles which in turn associate themselves with the liquid with which the material is wetted. The dry oil is removed at the upper end through a valve whose settings are controlled to maintain a constant level within the apparatus, while the water is removed from the lower portion of the chamber through a valve that is also controlled for the proper operation of the apparatus. This apparatus is limited by the mass of material within the chamber, as it tends to foul and thus the separation efficiency drops.

U.S. Pat. No. 4,053,414 by in'tVeld describes a closed tank for gravity separation of oil and water from large bodies of water. Within the tank are found cartridge type coalescing devices. Each of these coalescing devices includes: a cylindrical array of screens for retaining suitable material for separating particles of oil from water passing therethrough. The coalescing device includes a central cavity or passage. Under normal operating conditions, a pump produces a negative liquid pressure in the central cavity, which pulls the oily water gently from the outer periphery through the array of screens to produce a “partially clarified water” that enters into the central cavity via perforated tube for collection at the bottom of the coalescing device. The coalescing device includes a check valve at the top of the coalescing device arranged to permit flow upwardly through the coalescing device but to prevent down flow. The screen is designed for relatively low flows that minimizes turbulence and the mixing of oil particles. The flow can be reversed and the array of screens backwashed, with the collected oil at the central cavity discharged through the check valve. The means of feeding liquid through coalescing devices, via a negative pressure and the backwashing cycle cause intermittent stoppages in the production of the “partially clarified oil”, and thus overall throughput is reduced.

WO 2004/087286 A1 by A. Benachenhou describes a method and apparatus for oil water separation. The process and the absorbent material described is such that the absorbent material used effectively traps very finely dispersions of oil and water. The absorbent material can be effectively back-washed, via an apparatus that has an assortment of valves that can change the flowrate. This effective system allows the recovery of free-floating oil only during the backwash mode and requires that separated oil is collected only after complete passage through all the absorbent material, and otherwise limiting the throughput of the apparatus.

The present invention sets out to overcome the limitations of the prior art by increasing the flowrate of coalesced oil/water dispersions through the separator by permitting the of coalesce oil and clarified water removal from the separator during both regular operational mode and the back washing of the coalescing media mode, and permitting the use of the incoming or non-coalesced dispersion for backwash mode.

### SUMMARY OF THE INVENTION

Therefore it is one aim to separate a finely dispersed immiscible liquid dispersion, in an oil/water separator, particularly a cartridge type pressurized filter during a regular operational flow mode as well as during the backwashing mode.

In one aspect of the present invention there is provided A separator for separating an immiscible dispersion of oil from water and adapted for use with a flow generator, the separator comprising: a housing comprising a bottom portion, a top portion, a housing wall between the bottom portion and the top portion, a coalescing cartridge within the housing comprising a base part for attachment to the bottom portion of the housing, and defining at least one base aperture; a top part, opposite the base part, and defining at least one top aperture; and a coalescing media retained by the cartridge, the coalescing media defining at least one passage within the cartridge, the at least one passage in fluid communication with the bottom aperture and top aperture, the media coalescing the oil from the dispersion passing therethrough; and a flow regulator in liquid communication with the top aperture, the regulator comprising a constriction and the regulator displaceable between an open and a closed position and permitting a liquid flow out of the top aperture when in the open position.

In another aspect of the invention there is provided A separator for separating an immiscible dispersion of oil from water and adapted for use with a flow generator, the separator comprising: a housing comprising a bottom portion, a top portion, a housing wall between the bottom portion and the top portion, a coalescing cartridge within the housing comprising a base part for attachment to the bottom portion of the housing, and defining at least one base aperture; top part, opposite the base part, and defining at least one top aperture; and a coalescing media retained by the cartridge, the coalescing media defining at least one passage within the cartridge, the at least one passage in fluid communication with the bottom aperture and top aperture, the media coalescing the oil from the dispersion passing therethrough; a flow regulator in liquid communication with the top aperture, the regulator comprising a constriction and the regulator displaceable between an open and a closed position and permitting a liquid flow out of the top aperture when in the open position, and a flow generator feeding the dispersion into the passage.

In yet another aspect of the present invention there is provided a process for separating a dispersion of oil and water comprising the steps of feeding the dispersion through a flow generator in a first direction through a coalescing media in a cartridge separator, wherein the coalescing media produces a free oil and a clarified water; trapping the free oil outside the coalescing media and in a passage defined within the cartridge; feeding the flow of the dispersion through the coalescing media in a second direction opposite the first direction into the passage, and expelling the free oil within the cartridge via the flow in the second direction.

### BRIEF DESCRIPTION OF THE DRAWINGS

Further features and advantages will become apparent from the following detailed description, taken in combination with the appended drawings, in which:

FIG. 1 is a schematic representation of the oil/water separator with liquid flows indicated in Operational mode, in accordance with one embodiment of the present invention;

FIG. 2 is a schematic representation of the oil/water separator of FIG. 1 with liquid flows indicated in Backwash mode;

FIG. 3 is a schematic representation of the oil/water separator with liquid flows indicated in Operational mode, in accordance with a second embodiment of the present invention, where the coalescing cartridge comprises two central cavities;

FIG. 4 is a schematic representation of the oil/water separator of FIG. 3 with liquid flows indicated in Backwash mode; and

FIG. 5 is a perspective view of a coalescing cartridge of FIG. 3.

### DETAILED DESCRIPTION OF THE PREFERRED EMBODIMENT

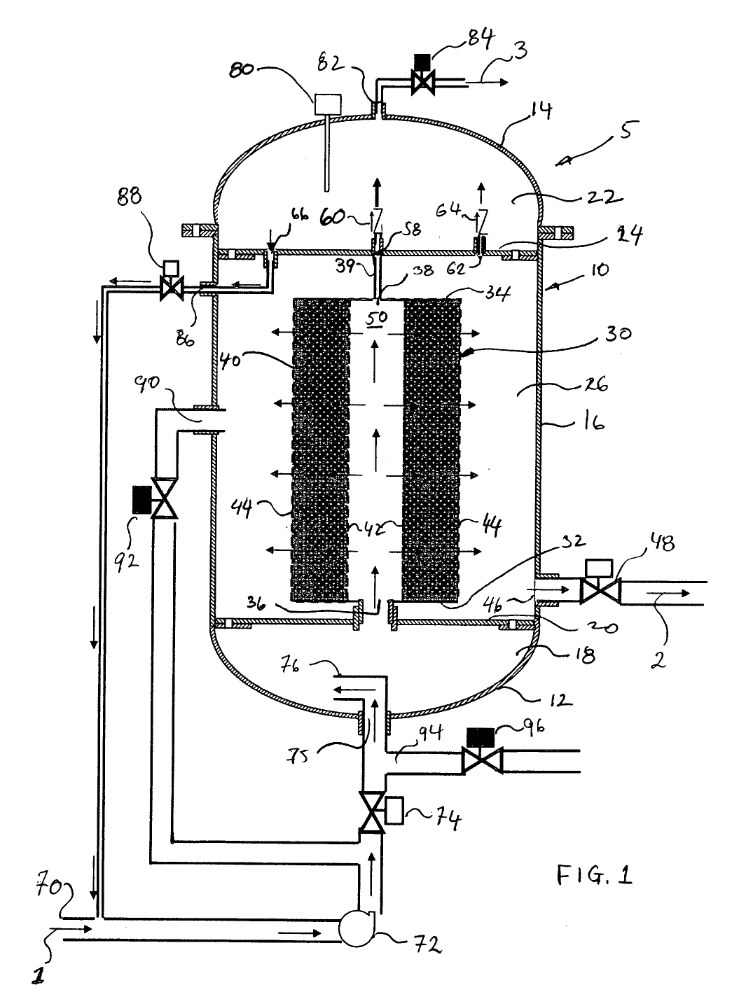

Referring to FIG. 1, there is presented a schematic flowsheet of a separator 5 according to one embodiment of the present invention illustrating the regular operational mode for separating oil and water dispersions with the present separator.

Various immiscible liquids can be separated by the apparatus of the present invention. However the present description will describe the case where the immiscible liquids in dispersion, are a non-aqueous and an aqueous liquid, and particularly an oil and water or water solution, and where the non-aqueous oil is less dense that the water. The oil will also be assumed to be in a lower mass ratio compared to the water in the dispersion. A dispersion, will be understood as a finely mixed particles of oil in a continuous water phase. The skilled practitioner would understand that the separator would operate in a similar manner for other immiscible liquids, and in the case were the oil is more dense than the water and oil would be in a greater mass ratio compared to the water in the dispersion.

A dispersion is understood to be a fine suspension of immiscible (do not dissolve in one another) liquids. In this case the non-aqueous liquid is an oil phase is distributed in very fine particles, in the continuous aqueous phase, water. The fine suspension of oil droplets in the aqueous phase may also be called emulsified oil. Due to their small size, the very fine oil droplets, may remain in suspension for long periods of time because the buoyancy over the oil droplets cannot over come the Brownian motion within the aqueous phase. For the separation to occur between the oil and water, the very fine oil droplets must coalesce into larger particles, having a buoyancy force sufficient to overcome the Brownian motion, and will rise to the top surface of the water due to their lower density than water.

The separator 5 of the present invention in a preferred embodiment includes a plurality of valves (48, 74, 84, 88, 92 and 96) which can be remotely controlled. In the context of the present description “remotely controlled” is understood to mean that the valve is controllable and may be either opened or closed remotely and with or without operator intervention.

The separator 5 has a housing 10 which can be pressurized and is designed for the liquids being separated. The housing 10 includes a bottom portion 12, a housing wall 16 and a top portion 14. The housing 10 has a plurality of liquid inlets and outlets that discharge the oil from the top portion 14 and the more dense water from the bottom portion 12 of the housing 10. The housing 10 in a preferred embodiment may define a bottom chamber 18, defined about the bottom portion 12 of the housing 10, and a bottom partition 20 spanning the distance between the housing wall 16. The bottom partition 20 is understood to include at least one opening through which the dispersion is introduced into the cavity or passage 50 of the cartridge 30. The bottom partition includes an upper surface on which the cartridge 30 is typically mounted.

Similarly, the separator 5 may include a top chamber 22 defined about the top portion 14 of the housing 10, and a top partition 24, spanning the housing wall 16. The top partition 24 is understood to include a plurality of apertures through which the coalesced oil will pass, before being discharged from the separator 5.

The separation of the oil in water is achieved in a coalescing cartridge 30, which is mounted in the housing 10, typically in a central chamber 26. In a preferred embodiment, the coalescing cartridge 30 is mounted on an upper surface to the bottom partition 20, which defines at least one opening in the partition 20, where the at least one opening is substantially aligned with the passage 50 of the cartridge 30. The coalescing cartridge 30, includes a base part 32, and a top part 34 that respectively include: at least one base aperture 36 to be aligned with the opening in the bottom partition 20, and at least one top aperture 38. Between the base part 32 and the top part 34 of the coalescing cartridge 30, a coalescing media 40 is retained between an inner pervious wall 42 and an outer pervious wall 44.

The two pervious walls 42 and 44 are adapted to retain the coalescing media 40 while allowing the dispersion 1 through the media 40. The coalescing media temporarily traps the very fine oil droplets due in part to its high surface properties and affinity for oil droplets. The trapped oil droplet then can contact and combine (or coalesce) with another fine oil droplets. When the coalesced droplet attains a specific size it will be released from the coalescing media and flow out of the media in the direction of flow of the dispersion. Thus, the coalesced oil leaves the coalescing media 40 as a larger diameter droplet then when it entered. These larger droplets leave at the top part 34 of the cartridge 30, while the denser clarified water leaves the media 40 at the base part 32 of the cartridge. Furthermore, the larger oil droplets will coalesce with each other to form an almost continuous phase of oil, in the top portion of the separator. In a preferred embodiment the coalescing media 40 is retained between the inner and outer pervious walls 42 and 44, and has a substantially annular shape within the cartridge 30. Thus FIG. 1 illustrates a cross section of the cartridge 30, and although the two pervious walls 42 and 44 are represented as two dotted lines in FIG. 1, in a preferred embodiment, each pervious wall 42, 44 is a substantially cylindrical surface. In a preferred embodiment the coalescing media 40 used, is that disclosed in WO 2004/087286, and is capable of entrapping oil droplets as small as 0.5 μm. However, this coalescing media may be used in combination with other absorbents such a clay, granular activated carbon, anthracite. Therefore, various coalescing medias are possible and may be used alone or in combination, and these would be known to the skilled practitioner.

In a preferred embodiment, where the coalescing media of WO 2004/087286 is used, the linear thickness of the coalescing media (i.e. the horizontal linear distance between the two pervious walls 42 and 44) should be between 2 and 5 inches. With a particularly preferred linear thickness range of between 3 and 4 inches. A preferred hydraulic flowrate through the media of WO 2004/087286 is in a range of 10 to 70 m³/h of liquid dispersion/m² of cross sectional surface area of filtration media. A particularly preferred hydraulic flowrate through the media is 40 to 65 m³/h dispersion/m² of cross sectional surface area of filtration media.

The cartridge 30 further defines a passage 50, in liquid communication with the bottom and top apertures 36, 38 in the respective partitions.

The separator 5 also includes a flow regulator 60 connected at that the top aperture 38. The flow regulator 60 defines a constriction or narrowing and has the ability to move between an open position allowing flow therethrough and a closed position where there is little to no flow through the regulator 60. The constriction is defined as a narrowing of the flow channel, may be achieved by various means of reducing the diameter, or by throttling a valve or both. In its simplest embodiment, the flow regulator 60 is a check valve (with other embodiments known to the skilled practitioner) which is installed such that liquid flow is out from the passage 50 towards the top portion 14 of the separator, and in a preferred embodiment into the top chamber 22. The constriction at the flow regulator 60 is sized such that the diameter through the flow regulator 60 is substantially smaller than the bottom aperture 36. In a preferred embodiment the top aperture 38 may also be minimized to better accommodate the flow regulator 60. Thus the constriction may begin in the top tube 39 defining the top aperture 38. Alternatively, the flow regulator 60 may be attached directly to the top part 34 at the top aperture 38, precluding the need for a tube 39, and the constriction would be produced within the flow regulator 60.

Referring once again to FIG. 1 illustrating the operational mode for the separation of the oil and water according to one embodiment of the present invention, the immiscible oil/water dispersion 1 (illustrated with an arrow) enters the separator via inlet 70. The direction of the flow of the dispersion 1 in the operational mode is indicated by a plurality of arrows presented in FIG. 1. From inlet 70, the dispersion is drawn into a flow generator or pump 72, and pumped through a housing inlet valve 74, which is in a preferred embodiment is remotely controlled. Pumping an immiscible liquid dispersion normally causes a further dispersion of the liquids and is usually to be avoided, however due to the efficiency of the present invention, the positive pressure developed by a pump 72 is normally used to feed the separator 5 and ultimately the passage 50. The separator 5 is adapted to operate with a pump 72, but the skilled person would understand that other means of pressurizing the dispersion into the separator 5 are known in the art.

The valves represented in the figures either have a white stem or a black stem. A valve represented with a white stem indicates an open valve and thus allows the passage of the dispersion, while a black stem indicates that the valve is closed and does not allow passage of the liquid.

From valve 74, the dispersion enters the bottom portion 12 of the separator through an opening 75 in the bottom of the housing 5. The skilled practitioner would understand that the dispersion could alternatively be pumped directly into the bottom of the coalescing cartridge 30. However, in the embodiment illustrated in FIG. 1 the dispersion is pumped into the bottom chamber 18, where the pressure drop caused by the expansion into the chamber helps to begin the process of separation of the water and oil. In a preferred embodiment the dispersion enters the bottom chamber 18 through a pipe extension 76, which is typically angled away from the base aperture 36 at the base part 32 of the coalescing cartridge 30.

The dispersion 1 then enters the passage 50 of the coalescing cartridge 30 where the pressure developed by the pump 72 forces the dispersion outwardly through the coalescing media 40 which contacts the oil and water dispersion and produces a separation of the water and oil.

The pumped dispersion is further forced out through the top aperture 38 and the flow regulator 60. As has been previously discussed the flow regulator 60 and possibly the top aperture 38 include a constriction which ensures that the flow rate through the regulator 60, is a minimum and the majority of the flow from the pump 72 passes through the coalescing media 40. Clearly, if a top partition 22 is included there must be various apertures that include an oil aperture 58 in liquid communication with the top aperture 38.

Furthermore and as will be understood by the skilled practitioner, due to the cyclical nature of the present process (between the operational mode and the backwash mode and back), coalesced oil will have accumulated at the top part 34 of the coalescing cartridge 30 and the pressure of the dispersion entering the passage 50 will expel the coalesce oil through the flow regulator 60, and will also promote coalescing of the dispersion 5 in the coalesced oil. The regulator 60 through aperture 58 further allows recovery of free or coalesced oil, the pressure of the dispersion 1 entering the passage 50, expels the free oil through the regulator 60, and without the dispersion 1 passing through the media 40. Thus the present invention, permits emulsified oils mainly to pass through the media 40 and minimizes the passage of free or coalesced oil back through the media 40. It is believed that minimizing the passage of free oil through the media is likely to markedly extend the lifetime of the media.

Therefore it will be understood that a small amount of the dispersion, may not pass through the coalescing media 40 but be directly transferred into the top portion 14 (top chamber 22) of the separator 5. Thus although a small amount of the dispersion is not directly treated by the coalescing media the dispersion does come into contact with the coalesced oil and may coalesce into larger oil droplets. The constriction and the flow regulator are designed to minimize this flow of dispersion.

The oil and water that are separated in the coalescing media 40 leave the cartridge 30 at the periphery through the outer pervious wall 44, as a coalesced or free oil and a clarified water. The coalesced oil leaves at the upper part of the cartridge 30 and proceeds to float towards that top portion 14 of the housing 10. In a preferred embodiment the separated oil floats towards the upper partition 24 which includes at least one peripheral aperture 62 which typically includes an oil flow regulator 64. The peripheral aperture 62 and flow regulator 64 ensure that the flow of oil is towards the top chamber 22 in the top portion of the housing 14. The oil flow regulator 64 is in its simplest embodiment a check valve, however various other alternatives, including an automated valve, would be within the purview of the skilled person. Although only on peripheral outlet 62 and flow regulator 64 are illustrated, clearly more than one outlet and regulator may be used. In a preferred embodiment the at least one peripheral outlet 62 and flow regulator 64 are located in the partition 24, at a position radially outward of the location of the outer pervious layer 42, thus trapping the coalesced oil leaving the coalescing media 40 in operational mode more easily.

During the regular operational mode according to one embodiment of the present invention, the flow of liquid through flow regulator 60 is greater than the flow through flow regulator 64, this is illustrated in FIG. 1 by a thicker arrow leaving flow regulator 60, and a thinner arrow leaving flow regulator 64.

The separated water leaving the coalescing media 40, leaves by the lower part of the cartridge 30 and is removed typically from the central chamber 26 of the housing at water outlet 46 equipped with a valve 48, that is in a preferred embodiment remotely controlled. The clarified water leaves the separator 5 is indicated by arrow 2 through outlet 46.

The top portion 14 of the housing 10 includes at least one coalesced oil outlet 82 which is equipped with a oil valve 84, that is remotely controlled in a preferred embodiment.

The control of the coalesced oil and the recirculation of the decanted water in the top chamber 22 includes a level control instrument or probe 80. The probe 80 monitors the level of the oil/water interface in the top chamber 22. As the coalesced oil enters the top chamber 22, the level of the oil/water interface will change. The level probe 80 will monitor the oil/water interface, and actuate valves 84 and 88. Coalesced oil 3 leaves through outlet 82 via valve 84, while water from the top chamber 22 leaves via water recirculation outlet 86 and via water recirculation valve 88. In a preferred embodiment, outlet 86 is connected via water recirculation aperture 66, in top partition 24. The skilled practitioner would understand that outlet 86 can also be located at a point of the housing wall 16 just above the top partition 24. Furthermore, the coalesced oil outlet 82 must be disposed above the water recirculation outlet 86. Typically, in normal operational mode, valve 84 is closed and valve 88 is open, thus the amount of oil in the top chamber 22 accumulates and the oil/water interface as measured by the level control probe 80 descends indicating more oil in the top chamber 22 than water. Once the level of the oil/water interface reaches a predetermined point, valve 84 opens while the valve 88 will close thus the oil accumulated in the top chamber 22 will be expelled. The controlled valves will be returned to their usual operational position previous described when the oil/water interface reaches an upper value, thus allowing oil once again to accumulate in the top chamber 22.

The water leaving via valve 88 is recirculated through the pump, and further reduces the percentage of oil in the oil/water dispersion 1 entering the separator 5.

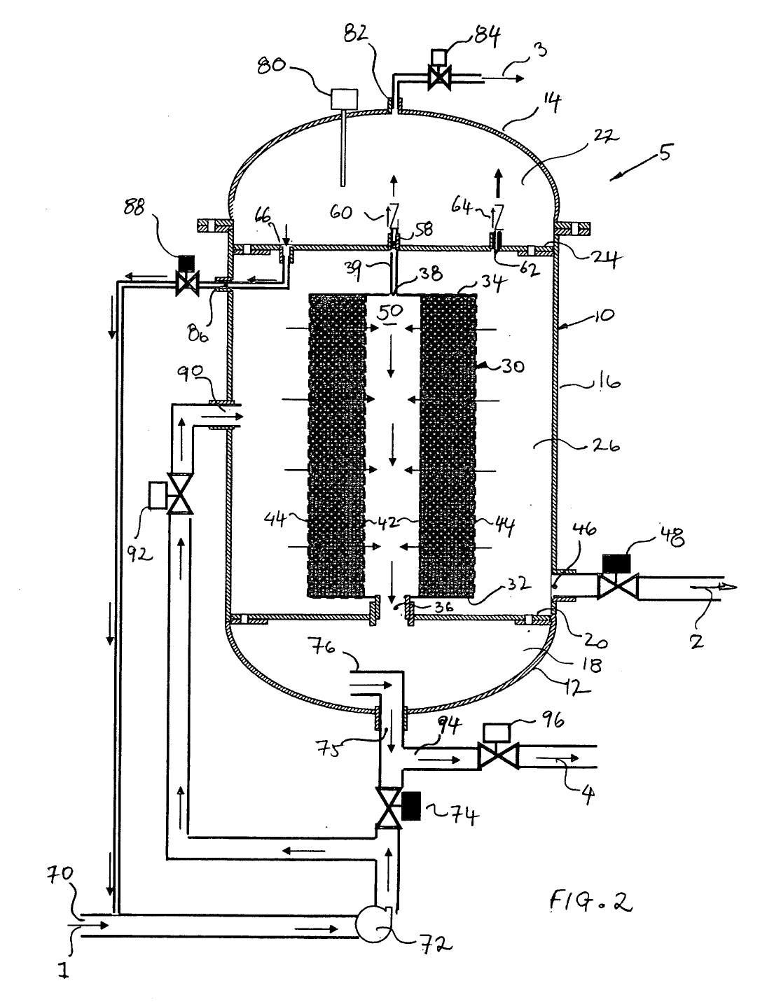

Turning to FIG. 2, the backwash mode operation of the embodiment of FIG. 1 is illustrated. Backwash mode interestingly uses the original oil water feed dispersion 1, and the dispersion flow through the coalescing cartridge 30 is effectively reversed. This reversal of the dispersion's flow will expel accumulated coalesced oil and any solid particles that may have lodged in the coalescing media 40.

In a preferred embodiment, the backwash mode is begun after a given time interval. This given time interval, is typically established the measurement of differential pressure through the separator 5 as a whole. Thus in a preferred embodiment, the cartridge 30 will include a differential pressure measurement linked to a controller or control system (neither are illustrated in the Figures) which measures the pressure differential between the passage 50 and the central chamber 126. If an excess pressure differential is measured the controller or control system will automatically change the position of the valves 48, 74, 84, 88, 92 and 96 from operational mode to backwash mode.

In backwash mode the dispersion is once again drawn into the pump 72 from where it is directed to the separator 5. However, in backwash mode valve 74 is closed which diverts the flow towards a backwash inlet valve 92 which is opened, and in a preferred embodiment can be remotely controlled. This permits the flow of the dispersion into the housing 10, via backwash inlet 90. In a preferred embodiment the dispersion enters the central chamber 26 of the housing 10.

The flow of the dispersion 1 entering the central chamber 26 moves from the periphery of the central chamber into the coalescing cartridge 30, via the outer pervious wall 44 in a direction towards the passage 50. The flow of the dispersion is once again illustrated by the direction of the plurality of arrows of FIG. 2. The pressure in the central chamber 26 is such that the dispersion pushes the oil clarified during regular operational mode predominantly through the at least one peripheral aperture 62. The dispersion also passes through the coalescing media 40, to dislodge any trapped particles or oil droplets, back towards the passage 50. A minor percentage of the dispersion 1 flow, pressurizes collected oil at the top part 34 of the coalescing cartridge, such that it passes through the top aperture 38 and across the flow regulator 60. The remaining flow of mainly clarified water in the passage 50 is directed downward towards the bottom portion 12 of the housing 10.

In one embodiment, the clarified water is directed towards, the bottom chamber 18. From the bottom chamber 18 the clarified water enters inlet 75, which is now being used as an outlet. With valve 74 closed the flow of clarified water is directed towards a clarified water by-pass 94 and a clarified water backwash valve 96, which is open. In a preferred embodiment, valve 96 may also be remotely controlled.

During backwash mode, oil which may have collected at the top portion 14 of the housing may also be expelled via valve 84, in a similar manner as previously described with valve 88 closed. Furthermore, the flow rate across the peripheral aperture 64 is greater than that across oil aperture 58 during backwash mode. This is illustrated in FIG. 2 by a thicker arrow leaving regulator 64 and a thinner arrow leaving flow regulator 60.

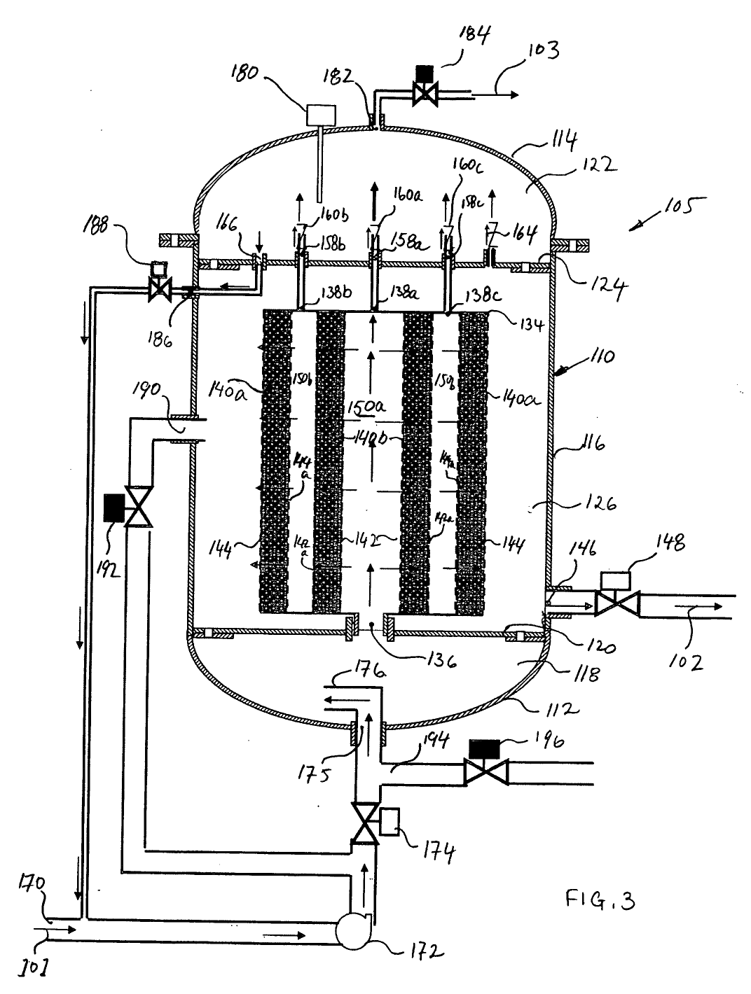

Turning to FIG. 3, we note that it is very similar to FIG. 1 and illustrates the operation of another embodiment of the present invention in operational mode. The reference numeral for each element of FIG. 3, shares the same dual numerical suffix with the element identified in FIG. 1, but includes a prefix 100. For example, the reference numeral of element 176, is understood to represent the pipe extension in FIG. 3, while the 76 is used for the pipe extension in FIG. 1.

Turning to the coalescing cartridge 130 illustrated in FIG. 3. In this embodiment the cartridge 130 comprises two cavities 150a and 150b. The coalescing media 140a and 140b is retained in two substantially annular rings, held respectively between pervious wall 144, 144a and 142a and 142.

During operational mode the flow of the dispersion 101, is via pump 172, through valve 174, bottom opening 175 and pipe extension 176 into the bottom portion 112 of the separator 105. In a preferred embodiment the bottom portion 112 and the bottom partition 120 define a bottom chamber 118. The cartridge 130 may once again be mounted on a top surface of the bottom partition 120. The dispersion 105 enters the cartridge 130 through a base aperture 136 and the flow progresses upward and laterally through the coalescing media 140b and 140a. Similarly as described in FIG. 1, the pressure of and a portion of the dispersion 105 pushes oil accumulated at the top part 134 of the cartridge 130 in cavity or passage 150a through a top aperture 138a, oil aperture 158a and flow regulator 160a, towards the top portion 114 of the separator 105. Furthermore, coalesced oil will also be transferred from the passage 150b, through at least one similar path. In FIG. 3 two such paths are illustrated particularly: from top apertures 138b,c, to oil aperture 158b,c, and to flow regulators 160b,c. The flow regulators 160a, b and c are in a preferred embodiment a check valve and include a constriction to limit liquid flow into the top chamber 122.

The operational mode of FIG. 3 from this point further is the same as described in FIG. 1. With the valves 148, 174, 184, 188, 192, and 196 operating as previously described. The coalesced oil leaves the separator 5 as previously described in association with probe 180 that is mounted in the top chamber 122.

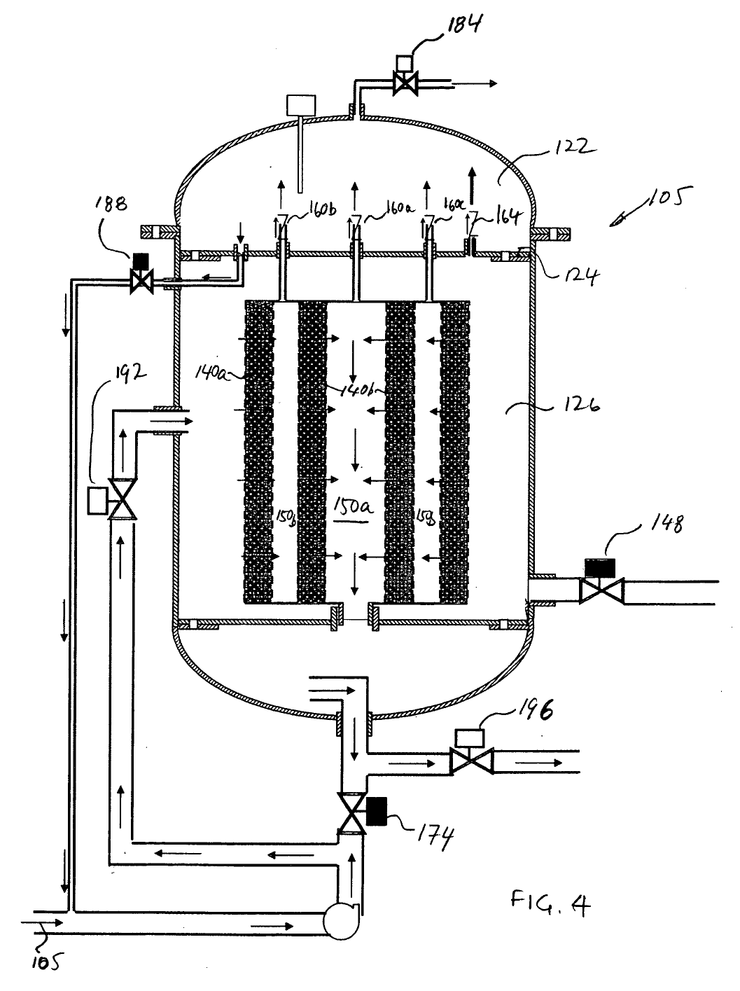

FIG. 4 represents the backwash mode which begins as before based on a timed interval or on pressure measurements across the coalescing media. As illustrated in FIG. 4 valves 148, 174, 184, 188, 192, and 196 are appropriately opened and closed, such that the flow of the dispersion 105, enters the central chamber 126, and forces the coalesced oil at the top partition 124 into the upper chamber 122. The dispersion also enters the coalescing media 140a, 140b peripherally and passes successively into cavities 150b and 150a. Any dislodged oil in the media 140 a, b, may be expelled through any one of flow regulators 160a, b, or c. The magnitude of the flows into the top chamber 122 is illustrated with the thickness of the arrows entering the top chamber. We note that the flow from oil flow regulator 164 is greater that the multiple flows from flow regulators 160a, b and c.

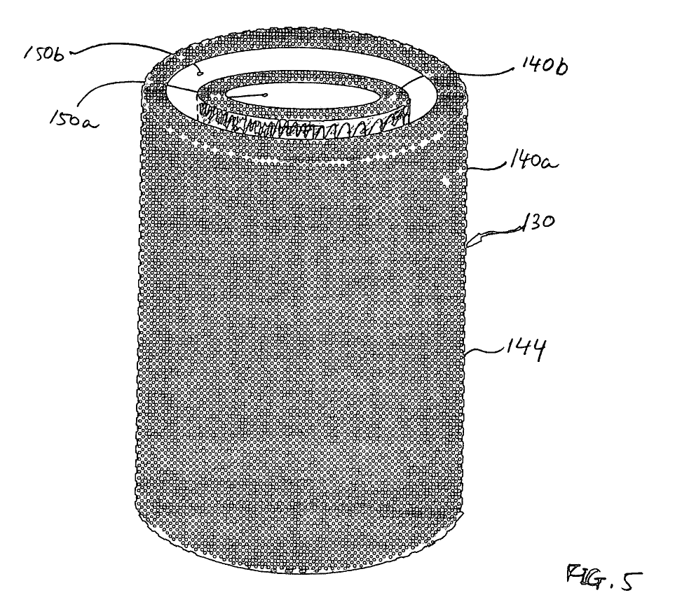

FIG. 5 illustrates the coalescing cartridge 130 of FIGS. 3 and 4 in a perspective view. The cartridge 130 comprises two zones of coalescing media, 140a and b, which in this case are annular in shape which define two central cavities 150a and b. The cartridge includes: an outer pervious wall 144 which may be made of a screen or perforated material compatible with oil and water and able to retain the coalescing media 140 irrespective of the direction of the flow of the liquid.

1. A separator for separating an immiscible dispersion of oil from water and adapted for use with a flow generator, the separator comprising:
a housing comprising
a bottom portion, a top portion, a housing wall between the bottom portion and the top portion,
a coalescing cartridge within the housing comprising
a base part for attachment to the bottom portion of the housing, and defining at least one base aperture;
a top part, opposite the base part, and defining at least one top aperture; and
a coalescing media retained by the cartridge, the coalescing media defining at least one passage within the cartridge, the at least one passage in fluid communication with the bottom aperture and top aperture, the media coalescing the oil from the dispersion passing therethrough; and
a flow regulator in liquid communication with the top aperture, the regulator comprising a constriction and the regulator displaceable between an open and a closed position and permitting a liquid flow out of the top aperture when in the open position.

2. The separator according to claim 1, further defining a top chamber in the top portion of the separator, the top chamber defined about the top portion and a top partition spanning the housing wall, the top partition comprising a plurality of apertures.

3. The separator according to claim 1, wherein a level probe for detecting an interface between the oil and the water is mounted in the top chamber.

4. The separator according to claim 3, wherein the level probe is operatively connected to a coalesced oil valve and water recirculation valve, wherein the coalesced oil valve and the water recirculation valves are each mounted at an outlet in the top portion, and the coalesced oil outlet is above the water recirculation outlet, whereby the level of the interface controls either a coalesced oil output or a water recirculation in the separator.

5. The separator according to claim 1, further defining a bottom chamber in the bottom portion of the separator, the bottom chamber defined about the bottom portion and a bottom partition spanning the housing wall, the bottom partition defining at least one opening.

6. The separator according to claim 5, wherein the bottom partition includes an upper surface on which the cartridge is mounted such that the passage and the at least one opening are substantially aligned.

7. The separator according to claim 1, wherein the cartridge comprises two passages and two zones of coalescing media.

8. The separator according to claim 1, wherein the flow regulator is a check valve.

9. A separator for separating an immiscible dispersion of oil from water and adapted for use with a flow generator, the separator comprising:
a housing comprising
a bottom portion, a top portion, a housing wall between the bottom portion and the top portion,
a coalescing cartridge within the housing comprising
a base part for attachment to the bottom portion of the housing, and defining at least one base aperture;
a top part, opposite the base part, and defining at least one top aperture; and
a coalescing media retained by the cartridge, the coalescing media defining at least one passage within the cartridge, the at least one passage in fluid communication with the bottom aperture and top aperture, the media coalescing the oil from the dispersion passing therethrough;
a flow regulator in liquid communication with the top aperture, the regulator comprising a constriction and the regulator displaceable between an open and a closed position and permitting a liquid flow out of the top aperture when in the open position, and
a flow generator feeding the dispersion into the passage.

10. The separator according to claim 9, further defining a top chamber in the top portion of the separator, the top chamber defined about the top portion and a top partition spanning the housing wall, the top partition defining a plurality of apertures.

11. The separator according to claim 10, wherein a level probe for detecting an interface between the oil and the water is mounted in the top chamber.

12. The separator according to claim 11, wherein the level probe is operatively connected to a coalesced oil valve and water recirculation valve, wherein the coalesced oil valve and the water recirculation valves are each mounted at an outlet in the top portion, and the coalesced oil outlet is above the water recirculation outlet, whereby the level of the interface controls either a coalesced oil output or a water recirculation in the separator.

13. The separator according to claim 9, further defining a bottom chamber in the bottom portion of the separator, the bottom chamber defined about the bottom portion and a bottom partition spanning the housing wall, the bottom partition defining at least one opening.

14. The separator according to claim 13, wherein the bottom partition includes an upper surface on which the cartridge is mounted such that the passage and the at least one opening are substantially aligned.

15. The separator according to claim 9, wherein the cartridge comprises two passages and two zones of coalescing media.

16. The separator according to claim 9, wherein the flow regulator is a check valve.

17. The separator according to claim 9, wherein dispersion is pressurized into the separator via the flow generator.

18. The separator according to claim 9, wherein the flow generator is a pump.

19. A process for separating a dispersion of oil and water comprising the steps of
feeding the dispersion through a flow generator in a first direction through a coalescing media in a cartridge separator, wherein the coalescing media produces a free oil and a clarified water;
trapping the free oil outside the coalescing media and in a passage defined within the cartridge;
feeding the flow of the dispersion through the coalescing media in a second direction opposite the first direction into the passage, and
expelling the free oil within the cartridge via the flow in the second direction.

20. The process according to claim 19, wherein the free oil is trapped outside the coalescing media at a top part of the cartridge, and is expelled through an aperture in the top part.
